(19) United States
(12) Patent Application Publication
(10) Pub. No.: US 2026/0017452 A1
(43) Pub. Date: Jan. 15, 2026

(54) DOCUMENT ANALYZING DEVICE AND DOCUMENT ANALYZING PROGRAM

(71) Applicant: Hitachi Astemo, Ltd., Hitachinaka-shi, Ibaraki (JP)

(72) Inventors: Mitsuhiro KITANI, Tokyo (JP); Man Yiu CHOW, Tokyo (JP); Masahiro MATSUBARA, Hitachinaka-shi (JP)

(73) Assignee: Hitachi Astemo, Ltd., Hitachinaka-shi, Ibaraki (JP)

(21) Appl. No.: 18/993,609

(22) PCT Filed: Jun. 8, 2023
(86) PCT No.: PCT/JP2023/021277

§ 371 Date: Jan. 13, 2025

(30) Foreign Application Priority Data
Aug. 30, 2022 (JP) 2022-136525

(51) Int. Cl. G06F 40/194; G06F 8/10; G06F 16/35; G06F 40/279

(52) U.S. Cl. CPC G06F 40/194; G06F 8/10; G06F 16/35; G06F 40/279

(57) ABSTRACT

Efficient use of software assets and efficiency of software development is enhanced utilizing a document analyzing device which includes a group classifying section which determines requirement items included in a first document as a target of analysis, and classifies the requirement items into a plurality of groups, a topic extracting section configured to extract, as topics, terms related to the requirement items classified into the plurality of groups, a topic difference extracting section which compares topics included in groups of an already analyzed second document different from the first document with the topics included in the groups of the first document, and extracts differences between the topics included in the groups of the second document and the topics included in the groups of the first document, and an analysis result output section outputs an analysis result indicating a result of the analysis including the differences to an outside.

### TECHNICAL FIELD

The present invention relates to a document analyzing device and a document analyzing program.

### BACKGROUND ART

It is generally known that, in software development, a document that is presented by a new customer and that describes requirement specifications or the like of software to be newly developed is analyzed, whether or not the reuse of software assets in the past is possible is examined according to a result of the analysis, and the software assets are used when the reuse is possible.

Such analysis and examination in a present situation are manually performed mainly by a developer or the like on the basis of the knowledge and experience of the developer or the like. However, when customer requirements are diverse, analysis work becomes complex. In addition, when software assets in the past increase, searching the software assets takes a tremendous amount of time. As a result, it is difficult to make effective use of the software assets in the past.

A system in which a computer assists in such analysis and examination is also known according to Patent Document 1, for example. Patent Document 1 discloses a technology that compares paragraph sentences as well as chapters and sections of documents by a computer and determines a degree of similarity between the two documents. This technology can only simply determine whether a new document includes a new paragraph in comparison with a document in the past, and is thus difficult to use to determine whether or not software assets in the past can be used in the development of the new software.

In addition, in a case where a new customer is different from a customer of software assets in the past, the description granularity (processes, methods, specifications, and the like) of requirements may be different. It is thus difficult to accurately extract a difference between the requirements of the new customer and requirements in the software assets in the past. As a result, it is difficult to identify usable software assets in the past.

### PRIOR ART DOCUMENT

### Patent Document

Patent Document 1: JP-2015-219799-A

### SUMMARY OF THE INVENTION

### Problems to be Solved by the Invention

The present disclosure has been made in view of the above-described problems, and provides a document analyzing device and a document analyzing program that enable efficient use of software assets in the past in software development and thereby enable efficiency of the software development to be enhanced.

### Means for Solving the Problems

In order to solve the above problems, according to the present disclosure, there is provided a document analyzing device including a group classifying section configured to determine requirement items included in a first document as a target of analysis, and classify the requirement items into a plurality of groups, a topic extracting section configured to extract, as topics, terms related to the requirement items classified into the plurality of groups, a topic difference extracting section configured to compare topics included in groups of an already analyzed second document different from the first document with the topics included in the groups of the first document, and extract differences between the topics included in the groups of the second document and the topics included in the groups of the first document, and an analysis result output section configured to output an analysis result indicating a result of the analysis including the differences to an outside.

### Advantages of the Invention

According to the document analyzing device in accordance with the present disclosure, it is possible to provide a document analyzing device and a document analyzing program that enable efficient use of software assets in the past in software development and thereby enable efficiency of the software development to be enhanced.

### BRIEF DESCRIPTION OF THE DRAWINGS

FIG. 1A is a schematic diagram of assistance in explaining a document analyzing device 200 and a user terminal 100 according to a first embodiment.

FIG. 1B is a block diagram of assistance in explaining a configuration of the document analyzing device 200 according to the first embodiment in more detail.

FIG. 2 is a schematic diagram of assistance in explaining analysis processing on a new requirement document in the document analyzing device 200 according to the first embodiment.

FIG. 3 is a schematic diagram of assistance in explaining a document analyzing device 200 and a user terminal 100 according to a second embodiment.

FIG. 4A is a flowchart of assistance in explaining procedures for new requirement document analysis processing and display control processing for an analysis result of the new requirement document as well as group classification verification processing, topic extraction verification, and score calculation processing in the document analyzing device 200 according to the second embodiment.

FIG. 4B is a flowchart of assistance in explaining the procedures for the new requirement document analysis processing and the display control processing for the analysis result of the new requirement document as well as the group classification verification processing, the topic extraction verification, and the score calculation processing in the document analyzing device 200 according to the second embodiment.

FIG. 5 is a diagram of assistance in explaining an example of screen display of a result of comparison between the new requirement document and a past requirement document in the user terminal 100 according to the second embodiment.

FIG. 6 is a diagram of assistance in explaining an example of screen display of the result of comparison between the new requirement document and the past requirement document in the user terminal 100 according to the second embodiment.

FIG. 7 is a diagram of assistance in explaining an example of screen display of the result of comparison between the new requirement document and the past requirement document in the user terminal 100 according to the second embodiment.

FIG. 8 is a diagram of assistance in explaining an example of screen display of the result of comparison between the new requirement document and the past requirement document in the user terminal 100 according to the second embodiment.

FIG. 9 is a diagram of assistance in explaining an example of screen display of a result of comparison between the new requirement document and the past requirement document in the user terminal 100 according to the second embodiment.

FIG. 10 is a diagram of assistance in explaining an example of screen display of a result of comparison between the new requirement document and past requirement documents in the user terminal 100 according to the second embodiment.

FIG. 11 is a flowchart of assistance in explaining an example of a procedure of analysis result display control processing in the user terminal 100 according to the second embodiment.

FIG. 12A is a flowchart of assistance in explaining the example of the procedure of the analysis result display control processing in the user terminal 100 according to the second embodiment.

FIG. 12B is a flowchart of assistance in explaining the example of the procedure of the analysis result display control processing in the user terminal 100 according to the second embodiment.

FIG. 13 is a flowchart of assistance in explaining an example of a procedure for update control of analysis result display in the second embodiment.

FIG. 14 is a flowchart of assistance in explaining the example of the procedure for the update control of the analysis result display in the second embodiment.

FIG. 15 is a flowchart of assistance in explaining a procedure of update control for updating the analysis results of the new requirement document in the second embodiment.

### MODES FOR CARRYING OUT THE INVENTION

The present embodiments will hereinafter be described with reference to the accompanying drawings. In the accompanying drawings, functionally identical elements may be indicated by the same numbers. Incidentally, while the accompanying drawings illustrate embodiments and implementation examples conforming to the principles of the present disclosure, these accompanying drawings are provided for understanding of the present disclosure, and are never used to interpret the present disclosure in a limited manner. The description of the present specification is merely a typical illustration, and does not limit the claims or examples of application of the present disclosure in any sense.

In the present embodiments, the description of the present disclosure is made in sufficient detail for those skilled in the art to carry out the present disclosure. However, it needs to be understood that other implementations and modes are also possible, and that changes in configurations and structures as well as replacements of various elements are possible without departing from the scope and spirit of technical concepts of the present disclosure. Hence, the following description should not be interpreted in such a manner as to be limited to the embodiments.

### First Embodiment

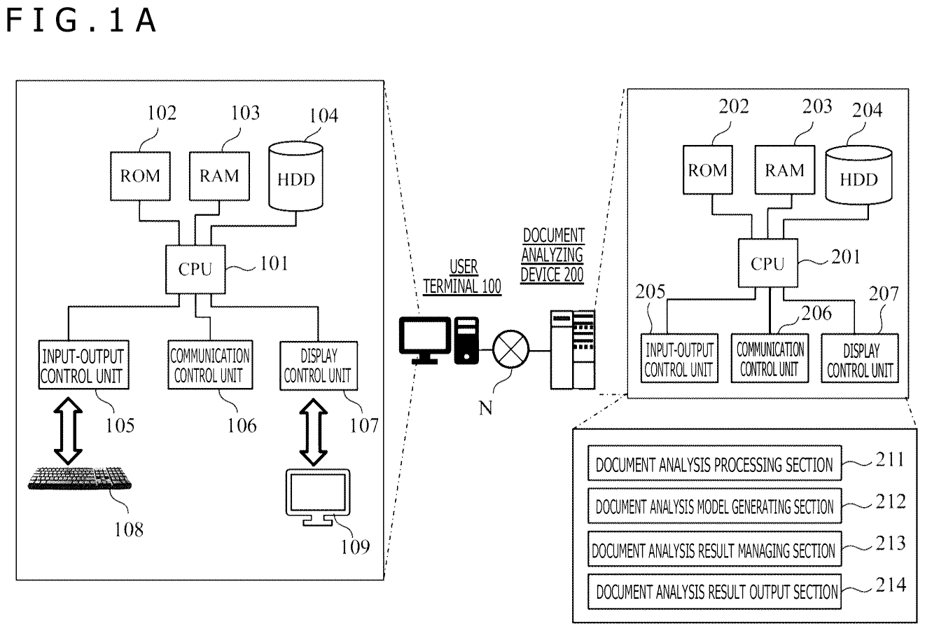

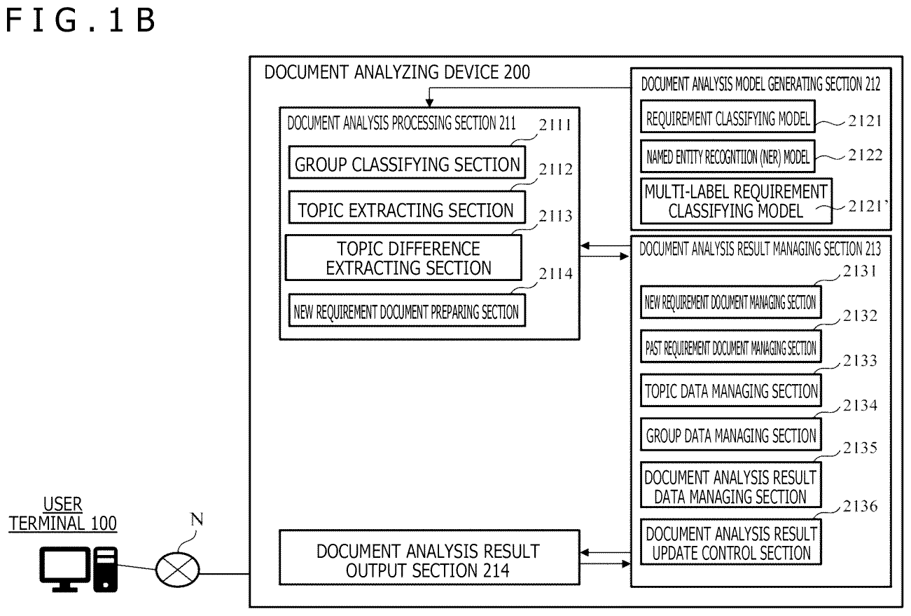

A document analyzing device 200 and a user terminal 100 according to a first embodiment will be described with reference to FIG. 1A. The document analyzing device 200 according to the first embodiment is connected to the user terminal 100, and is provided with a document related to design specifications or the like of software to be newly developed (the document will hereinafter be referred to as a “new requirement document” or a “first document”) from the user terminal 100.

The document analyzing device 200 analyzes the new requirement document, and according to a result of the analysis, identifies a document having a commonality with the new requirement document from among requirement documents in the past that are already analyzed and whose analysis results are already stored (the requirement documents in the past will hereinafter be referred to as “past requirement documents” or “second documents”). Then, the document analyzing device 200 identifies the commonality/difference/new features or the like between the identified related past requirement document and the new requirement document, and presents the commonality/difference/new features or the like to the user terminal 100. A user (software developer) of the user terminal 100 views the presented past requirement document and information regarding the commonality, the difference, and the new features, and can determine whether or not software assets in the past that are related to the past requirement document can be used for the development of new software related to the new requirement document.

The user terminal 100 can be constituted by a general-purpose personal computer or the like. The user terminal 100 includes, for example, a CPU 101, a ROM 102, a RAM 103, a hard disk drive 104, an input-output control unit 105, a communication control unit 106, a display control unit 107, an input device 108, and a display 109. A storage device such as the hard disk drive 104 stores a user interface application that constitutes a part of a document analyzing program for the operation of the document analyzing device 200 according to the present embodiment. Inputs for various kinds of instructions, editing operations, and the like from the user are performed from the input device 108. The display 109 can display an execution screen of the user interface application.

The document analyzing device 200 can similarly be constituted by a general-purpose personal computer or the like. The document analyzing device 200 includes, as an example, a CPU 201, a ROM 202, a RAM 203, a hard disk drive 204, an input-output control unit 205, a communication control unit 206, and a display control unit 207. A storage device such as the hard disk drive 204 stores the document analyzing program for the operation of the document analyzing device 200 according to the present embodiment. Though not illustrated in FIG. 1A, the document analyzing device 200 can include an input device to be operated by an administrator of the document analyzing device 200 or the like and a display for checking analysis operation.

The document analyzing program implements a document analysis processing section 211, a document analysis model generating section 212, a document analysis result managing section 213, and a document analysis result input-output section 214 in the document analyzing device 200. The document analysis processing section 211 is a part that receives the data concerning the new requirement document, and performs various kinds of analysis related to the new requirement document. In addition, the document analysis model generating section 212 is a part that generates a document analyzing model (a requirement classifying model and a Named Entity Recognition (NER) model) used for analysis in the document analysis processing section 211.

The document analysis result managing section 213 has a role of managing data related to an analysis result of the new requirement document, data related to an analysis result of the past requirement document, and various kinds of other data used for analysis. The document analysis result input-output section 214 has a function of generating display data for displaying the analysis result of the new requirement document on the user terminal 100 and outputting the display data to the user terminal 100, and receiving various kinds of inputs from the user terminal 100 or the like and changing the display data.

As illustrated in FIG. 1B, the document analysis processing section 211 further includes, as an example, a group classifying section 2111, a topic extracting section 2112, a topic difference extracting section 2113, and a new requirement document preparing section 2114. The group classifying section 2111 has a function of determining requirement items included in the new requirement document as a target for analysis, and classifying the requirement items into a plurality of groups. The topic extracting section 2112 has a role of extracting, as topics, terms related to terms (keywords) included in the requirement items classified into the plurality of groups. The topic difference extracting section 2113 has a role of comparing topics included in one group of an already analyzed past requirement document with topics included in a group of the new requirement document, and extracting a difference therebetween. The new requirement document preparing section 2114 has a function of generating the new requirement document including a result of extraction of the difference. Incidentally, the topic difference extracting section 2113 can have a function of computing a topic matching rate and a vector similarity degree, which are computed on the basis of the difference.

The document analysis model generating section 212 generates a requirement classifying model 2121 used for classification processing in the group classifying section 2111 of the document analysis processing section 211, and generates a Named Entity Recognition (NER) model 2122 used for topic extraction in the topic extracting section 2112. The requirement classifying model 2121 and the Named Entity Recognition (NER) model 2122 integrally constitute the document analyzing model. The document analyzing model can be updated as appropriate with use of technologies of natural language processing and machine learning. The topic extracting section 2112 can be constituted by one of or both a multi-label requirement classifying model 2121′ and the Named Entity Recognition (NER) model 2122. The multi-label requirement classifying model 2121′ is a model for providing the topic extracting section 2112 with a capability of extracting a plurality of topics. Meanwhile, the requirement classifying model 2121 is limited to a single label (group). The requirement classifying models 2121 and 2121′ and the Named Entity Recognition (NER) model 2122 can be implemented as mutually different models (software).

Incidentally, the Named Entity Recognition (NER) model 2122 can be omitted in some cases. In addition, as the requirement classifying model 2121 and the Named Entity Recognition (NER) model 2122, separate models may be generated according to groups. For example, in a case where the number of groups is 10, 10 Named Entity Recognition (NER) models 2122 and 10 requirement classifying models 2121 may be generated.

The document analysis result managing section 213 further includes, as an example, a new requirement document managing section 2131, a past requirement document managing section 2132, a topic data managing section 2133, a group data managing section 2134, a document analysis result data managing section 2135, and a document analysis result update control section 2136.

The new requirement document managing section 2131 has a role of managing the new requirement document. Specifically, the new requirement document managing section 2131 manages, for example, the text data of the new requirement document, a result of classification in the group classifying section 2111 for the new requirement document, a result of extraction in the topic extracting section 2112, and other data related to the new requirement document. The past requirement document managing section 2132 has a role of managing the past requirement document. Specifically, the past requirement document managing section 2132 manages the text data of the past requirement document, a result of classification in the group classifying section 2111 for the past requirement document, a result of extraction in the topic extracting section 2112, and other data related to the past requirement document.

The topic data managing section 2133 is used in topic extraction processing in the topic extracting section 2112. The topic data managing section 2133 manages data related to topics by use of a database. The group data managing section 2134 is used in classification processing in the group classifying section 2111. The group data managing section 2134 manages data related to groups by use of a database. The document analysis result data managing section 2135 has a role of managing analysis result data as the result of analysis of the new requirement document. The document analysis result update control section 2136 is in charge of update control for updating the analysis result data.

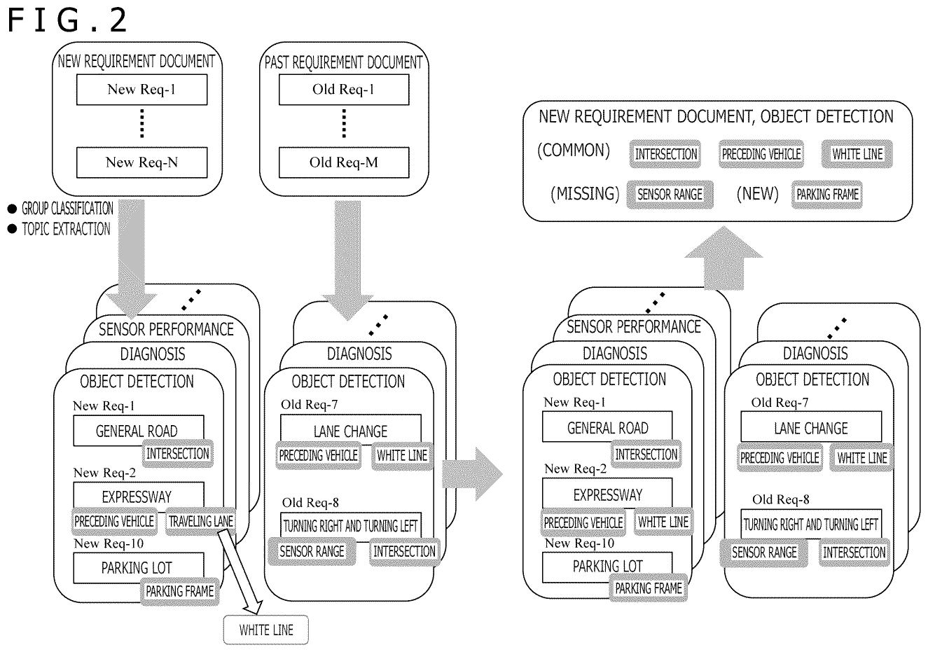

With reference to FIG. 2, description will be made of analysis processing on the new requirement document in the document analyzing device 200. As illustrated in the upper left of FIG. 2, the new requirement document includes a plurality of requirement items New Req-i. Similarly, the past requirement document includes a plurality of requirement items Old Req-i. Here, the “requirement items” are sentences expressing various kinds of requirements for the development of a system or service in one document. A requirement item may be a single sentence (sentence having only one period), or may be a plurality of sentences.

The requirement items New Req-i of the new requirement document are classified into a plurality of groups in the group classifying section 2111 according to contents thereof and in accordance with the requirement classifying model and a group database. As illustrated in FIG. 2, the groups include, as an example, “object detection,” “diagnosis,” “sensor performance,” and the like. The requirement items Old Req-i of the past requirement document are also similarly classified into a plurality of groups.

A requirement item New Req-i classified into one of the plurality of groups is set as a target for topic extraction processing in the topic extracting section 2112, and a term included in the requirement item New Req-i is extracted as a topic. Results of the group classification and the topic extraction are stored in the new requirement document managing section 2131.

Incidentally, the expressions (terms) of extracted topics are converted into other terms as appropriate in accordance with a topic database (for example, a “driving lane” is changed to a “white line”). That is, the “topics” can include not only the terms themselves included in the text of the new requirement document or the past requirement document but also terms related thereto (examples: broader terms, narrower terms, synonyms, and the like). The past requirement document is also similarly set as a target for topic extraction, and the result of the extraction is stored in the past requirement document managing section 2132.

When the results of the group classification and the topic extraction for the new requirement document are stored in the new requirement document managing section 2131, the topic difference extracting section 2113 of the document analysis processing section 211 compares topics between corresponding groups of the new requirement document and the past requirement document stored in the past requirement document managing section 2132, and extracts a difference between the topics in the two groups (a topic matching between the new requirement document and the past requirement document, a topic missing in the new requirement document, and a new topic in the new requirement document). Such an extraction is performed between the new requirement document and a plurality of past requirement documents. The user of the user terminal 100 can view the result of this extraction, identify the past requirement document closest to the new requirement document, and use software assets in the past that are related to the past requirement document for software development related to the new requirement document.

Incidentally, the topic difference extracting section 2113 may extract a difference between topics in groups having the same or related group names. However, this is not restrictive, and the topic difference extracting section 2113 may be enabled to extract a difference between topics in groups having different group names. In addition, the targets of the comparative analysis in the topic difference extracting section 2113 do not need to be limited to two groups, and the targets of the comparative analysis may be any targets as long as the topics can be compared with each other. For example, a requirement item New Req in the new requirement document and a group of a past requirement document as a comparison target may be set as comparison targets.

As described above, the document analyzing device 200 according to the first embodiment classifies requirement items included in a document into groups, and further extracts terms in the requirement items as topics within the groups. Further, a degree of similarity to the past requirement document is determined by comparing the topics in each group. According to this, a past requirement document approximate to the new requirement document can be identified accurately.

### Second Embodiment

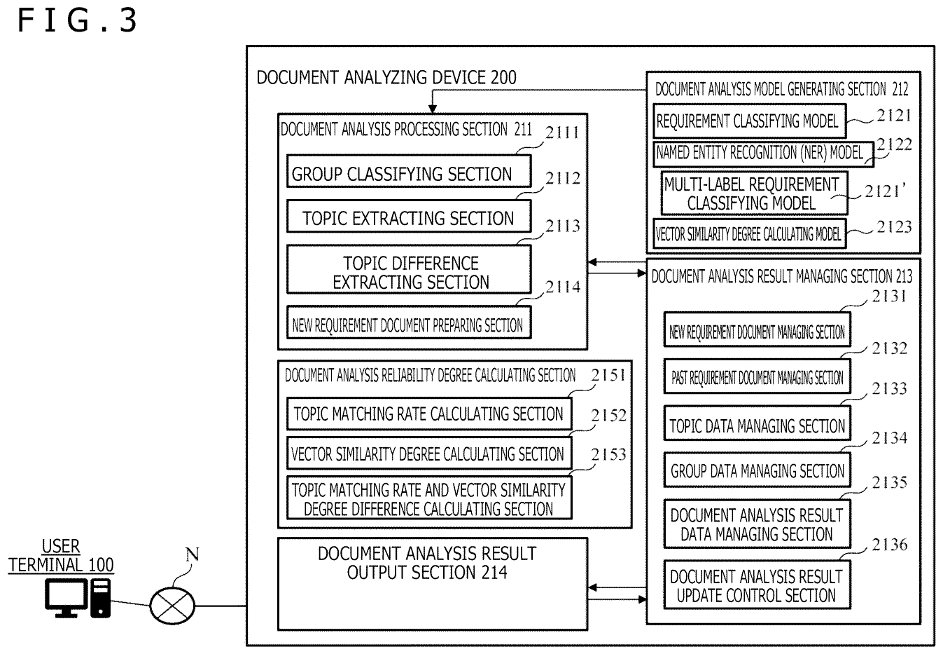

Next, with reference to FIG. 3, description will be made of a document analyzing device 200 according to a second embodiment. As in the first embodiment, the document analyzing device 200 according to the second embodiment is connected to the user terminal 100, and is provided with a document related to design specifications or the like of software to be newly developed (the document will hereinafter be referred to as a “new requirement document” or a “first document”) from the user terminal 100. Yet, the document analyzing device according to the present second embodiment includes a document analysis reliability degree calculating section 215 that calculates a degree of reliability of a result of document analysis, and the document analysis model generating section 212 includes a vector similarity degree calculating model generating section 2123. The document analyzing device according to the present second embodiment is different from that of the first embodiment in this respect. When the degree of reliability of the result of document analysis is calculated, and is presented to the user terminal 100, the result of the document analysis can be determined more accurately.

The document analysis reliability degree calculating section 215 includes, as an example, a topic matching rate calculating section 2151, a vector similarity degree calculating section 2152, and a topic matching rate and vector similarity degree difference calculating section 2153. The topic matching rate calculating section 2151 has a function of calculating a topic matching rate indicating the degree of matching of topics within groups between the new requirement document and the past requirement document. The vector similarity degree calculating section 2152 has a function of calculating the degree of similarity of the topics within the groups between the new requirement document and the past requirement document as a vector similarity degree such as a cosine similarity degree. The topic matching rate and vector similarity degree difference calculating section 2153 has a function of calculating the difference between the topic matching rate computed in the topic matching rate calculating section 2151 and the vector similarity degree computed in the vector similarity degree calculating section 2152, and comparing this difference with a threshold value. The degree of reliability of the document analysis can be determined according to a difference between the difference in question and the threshold value.

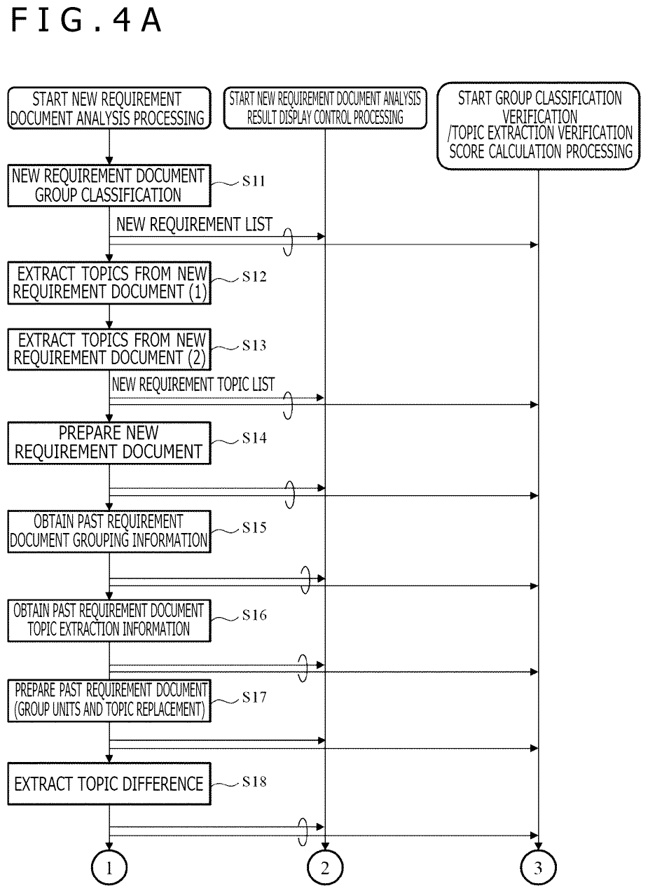

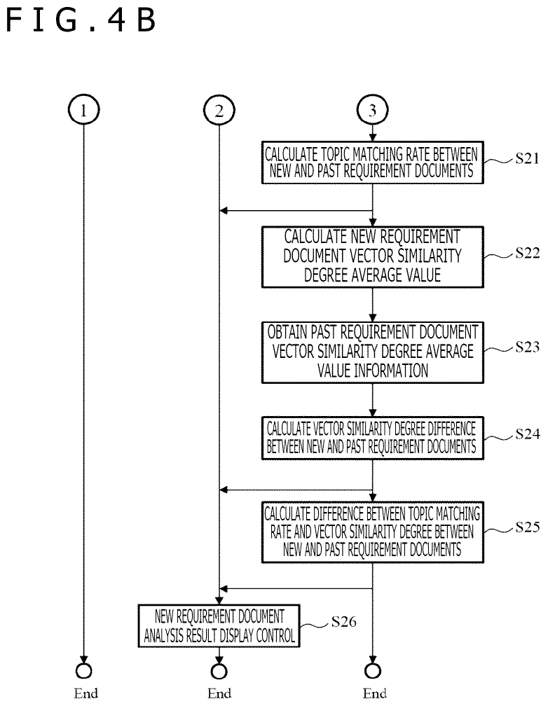

Next, with reference to a flowchart of FIG. 4A and FIG. 4B, description will be made of procedures for new requirement document analysis processing and display control processing for an analysis result of the new requirement document as well as group classification verification processing, topic extraction verification, and score calculation processing in the document analyzing device 200 according to the second embodiment.

In the new requirement document analysis processing, first, group classification for the requirement items included in the new requirement document is performed (step S11). Then, terms included in the classified requirement items are extracted as topics (steps S12 and S13). In step S12, the topics are extracted from the new requirement document according to the Named Entity Recognition (NER) model. In step S13, terms related to the topics extracted from the new requirement document are converted into other terms according to the topic database. A new requirement document resulting from the group classification and the topic extraction is generated according to a result of the topic extraction in steps S12 and S13 (step S14).

Next, from the past requirement document managing section 2132, group information concerning the past requirement document is obtained, and topic extraction information concerning the past requirement document is obtained (steps S15 and S16). Then, a past requirement document resulting from topic replacement in group units is generated as necessary (step S17). The new requirement document and the past requirement document thus generated are set as a target of topic difference extraction in group units (step S18).

After a topic difference between groups of the new requirement document and the past requirement document is extracted, a topic matching rate between the groups is calculated on the basis of the difference (step S21). Further, an average value of vector similarity degrees in group units in the new requirement document is calculated (step S22), and information regarding an average value of vector similarity degrees in group units in the past requirement document is read and obtained from the past requirement document managing section 2132 (step S23). Then, a difference in the vector similarity degree between the groups of the new requirement document and the past requirement document is calculated (step S24). Further, a difference between the topic matching rate and the vector similarity degree is calculated between the new requirement document and the past requirement document. The degree of reliability of the document analysis is thereby determined (step S25). Then, analysis according to results of the above-described various kinds of calculations is performed, and a result of the analysis is displayed on the user terminal 100 (step S26).

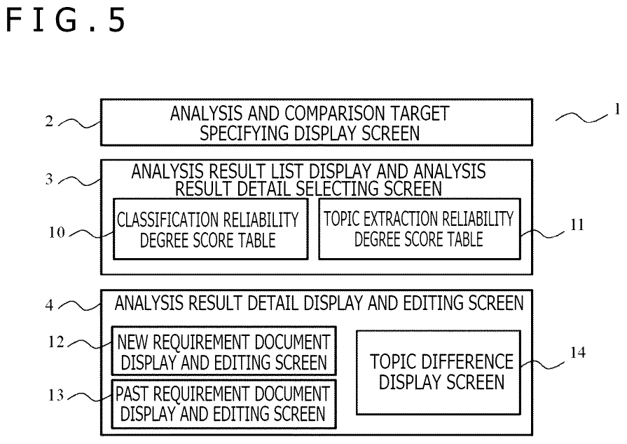

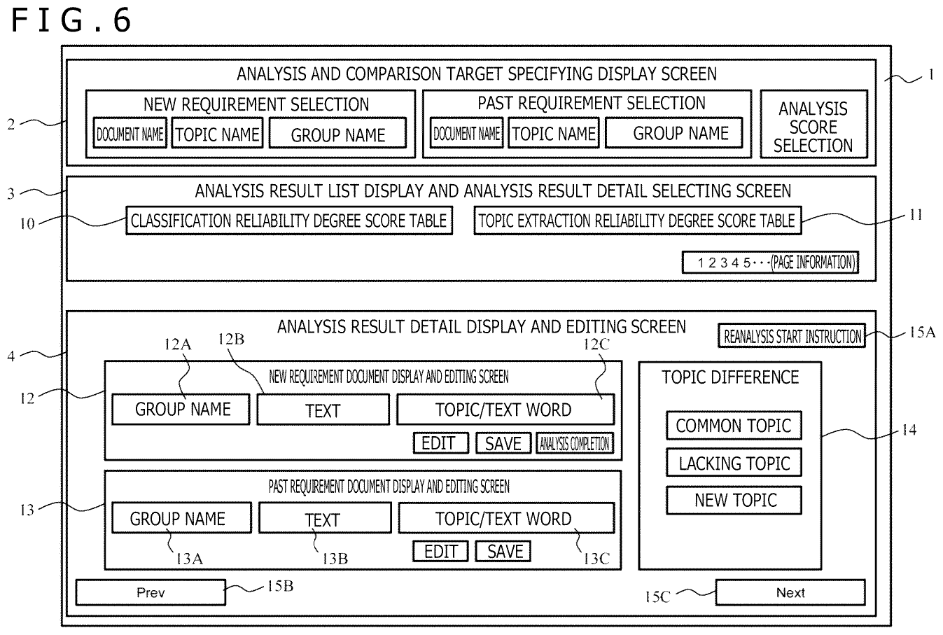

With reference to FIG. 5 and FIG. 6, description will be made of an example of a screen display of a result of comparison between the new requirement document and the past requirement document on the user terminal 100. FIG. 5 illustrates an outline of the screen. FIG. 6 illustrates a detailed example thereof. This screen includes, as an example, an analysis and comparison target specifying display screen 2, an analysis result list display and analysis result detail selecting screen 3, and an analysis result detail display and editing screen 4. The analysis and comparison target specifying display screen 2 includes a screen for specifying (selecting) the new requirement document as an analysis and comparison target, a screen for specifying (selecting) the past requirement document to be compared with the new requirement document, and a screen for selecting analysis scores of the two.

The analysis result list display and analysis result detail selecting screen 3 is a screen for displaying a list of analysis results of the new requirement document, and selectively displaying details of the analysis results. The analysis result list display and analysis result detail selecting screen 3 further includes, as an example, a classification reliability degree score table 10 and a topic extraction reliability degree score table 11. The classification reliability degree score table 10 displays a degree of reliability of determination in group classification as a score. The topic extraction reliability degree score table 11 displays a degree of reliability of topic extraction processing in the topic extracting section 2112 as a score.

The analysis result detail display and editing screen 4 includes, as an example, a new requirement document display and editing screen 12, a past requirement document display and editing screen 13, and a topic difference display screen 14. The new requirement document display and editing screen 12 is a screen for displaying and editing analysis results of the new requirement document. The past requirement document display and editing screen 13 is a screen for displaying and editing analysis results of the past requirement document to be compared with the new requirement document. The topic difference display screen 14 is a screen that displays a difference between the new requirement screen and the past requirement screen and various kinds of factors of the difference.

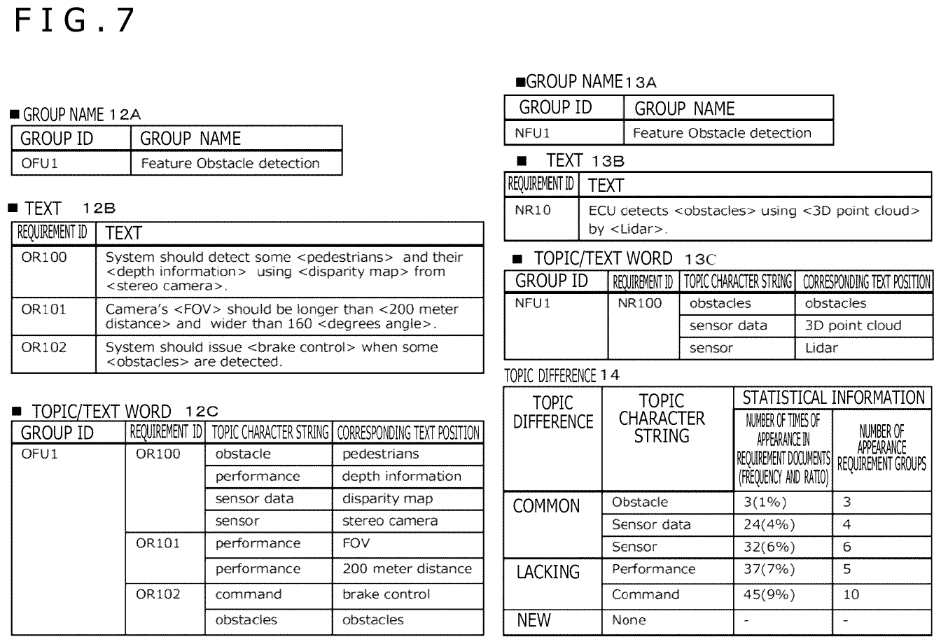

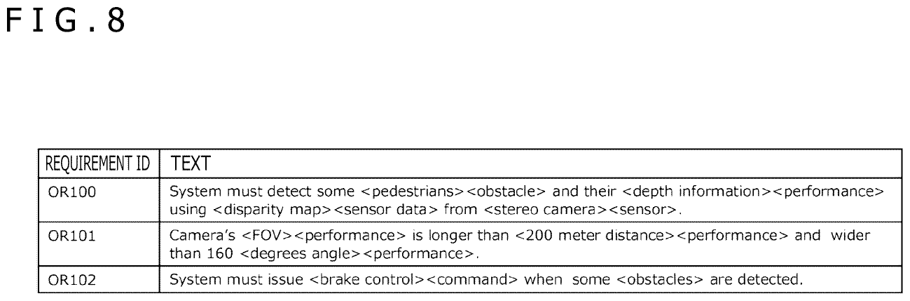

As illustrated in FIG. 6, the new requirement document display and editing screen 12 includes a group name display section 12A as the result of group classification for the new requirement document, a text display section 12B for displaying the text data of the new requirement document, and a topic/text word display section 12C for indicating correspondence relations between extracted topics and corresponding words in the text. Icons for giving instructions for editing, saving, and analysis completion of these pieces of data may be displayed below the sections 12A to 12C. FIG. 7 illustrates a specific example of display in the sections 12A to 12C. In the text display section 12B, the presence positions of the topics in the text can be indicated by symbols (such as <>), for example. In the topic/text word display section 12C in FIG. 7, relations between the topics and corresponding text positions can be recognized, and the expressions of the topics can be edited by the user on the user terminal 100 side. In addition, it is possible to check topic character strings and the corresponding text positions, and register the terms in the topic database or the like. Incidentally, the section 12B and the section 12C may be synthesized and displayed in one section, as illustrated in FIG. 8.

The past requirement document display and editing screen 13 includes a group name display section 13A as the result of group classification for the past requirement document set as a target of comparison with the new requirement document, a text display section 13B for displaying the text data of the past requirement document, and a topic/text word display section 13C for indicating correspondence relations between extracted topics and corresponding words in the text. Icons for giving instructions for editing and saving of these pieces of data may be displayed below the sections 13A to 13C. FIG. 7 illustrates a specific example of display in the sections 13A to 13C.

Incidentally, the analysis result detail display and editing screen 4 includes a reanalysis start instruction button 15A, a Prev button 15B, and a Next button 15C. The reanalysis start instruction button 15A is a button for giving an instruction to perform again analysis of the new requirement document and the past requirement document being displayed in the sections 12 and 13. The Prev button 15B and the Next button 15C are buttons for changing the display of the analysis result list narrowed down on the analysis and comparison target specifying display screen 2, that is, buttons for changing the past requirement document displayed on the past requirement document display and editing screen 13. Pressing the buttons changes the new requirement document, the past requirement document, and others displayed on the analysis and comparison target specifying display screen 2, and displays a new analysis result on the topic difference display screen 14.

The topic difference display screen 14 is a screen for displaying a topic difference between the new requirement document displayed on the screen 12 and the past requirement document displayed on the screen 13, in group units. Specifically, the topic difference display screen 14 displays a topic common to the two documents as a “common topic,” displays a topic existing only in the past requirement document and lacking (missing) in the new requirement document as a “lacking topic,” and displays a topic appearing only in the new requirement document as a “new topic.” FIG. 7 illustrates a specific example of display on the topic difference display screen 14.

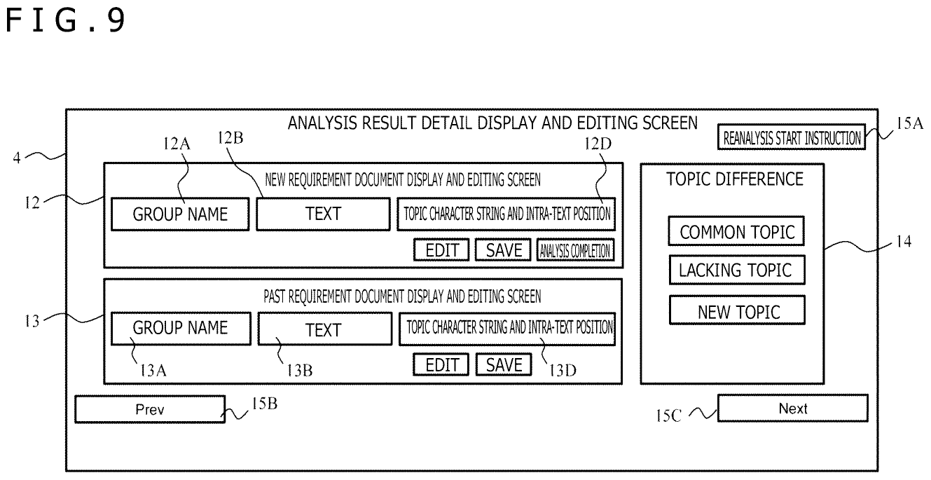

With reference to FIG. 9, description will be made of a first modification of screen display of a result of comparison between the new requirement document and the past requirement document on the user terminal 100. The screen display of FIG. 9 includes, on the new requirement document display and editing screen 12 and the past requirement document display and editing screen 13, topic character string and intra-text position display sections 12D and 13D for indicating the character strings of the extracted topics and the positions at which the terms corresponding to the topics appear in the text. The screen display of FIG. 9 is different from the display example of FIG. 6 in this respect. The indication of the character strings of the topics and the appearance positions in the text of the corresponding terms makes the comparison between the new requirement document and the past requirement document easier.

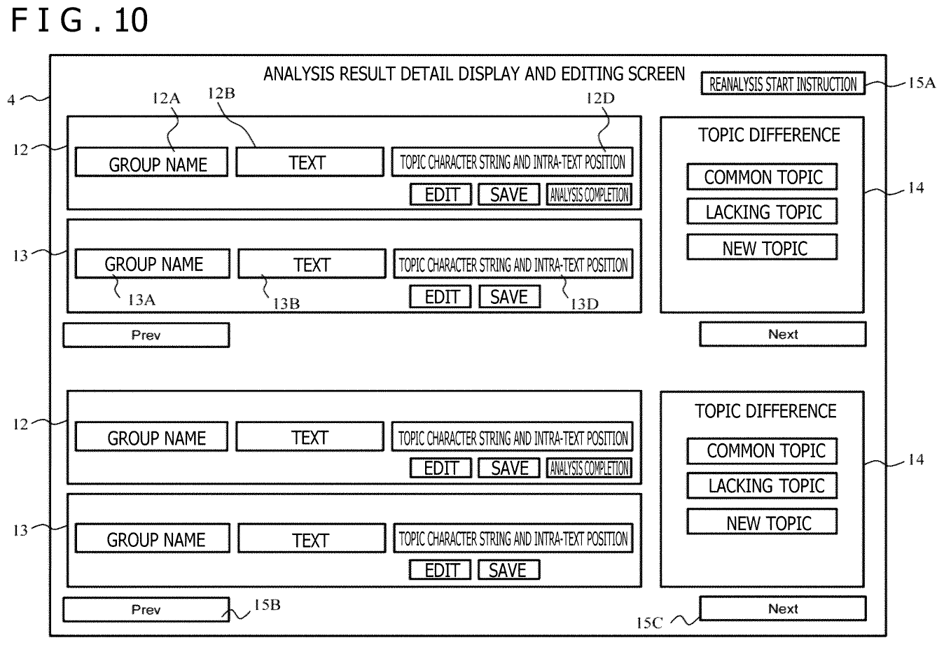

With reference to FIG. 10, description will be made of a second modification of screen display of a result of comparison between the new requirement document and past requirement documents on the user terminal 100. The screen display of FIG. 10 displays a plurality of sets of a new requirement document display and editing screen 12 and a past requirement document display and editing screen 13 in parallel with each other. The screen display of FIG. 10 is different from the display example of FIG. 6 in this respect. Results of comparison of a plurality of past requirement documents are displayed on one screen in this manner. The user of the user terminal 100 can determine more easily which of the plurality of past requirement documents has a high similarity to the new requirement document.

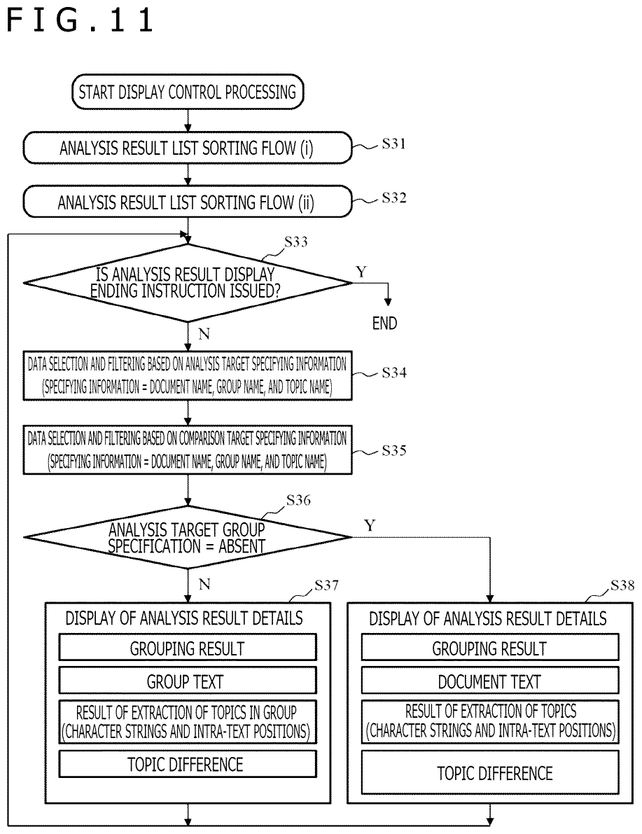

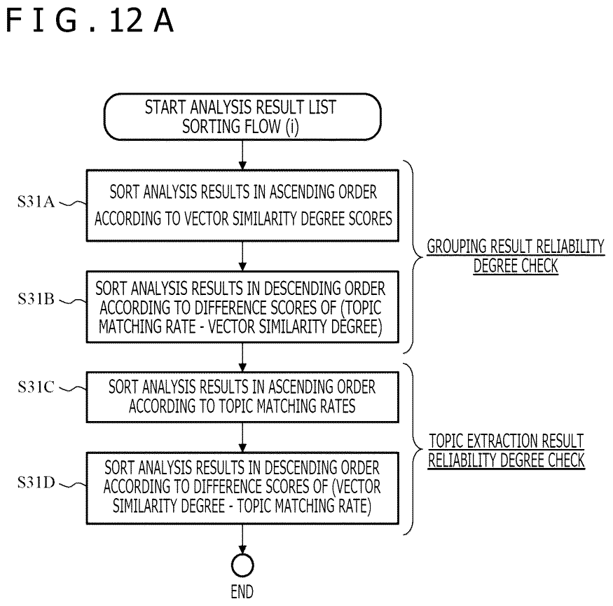

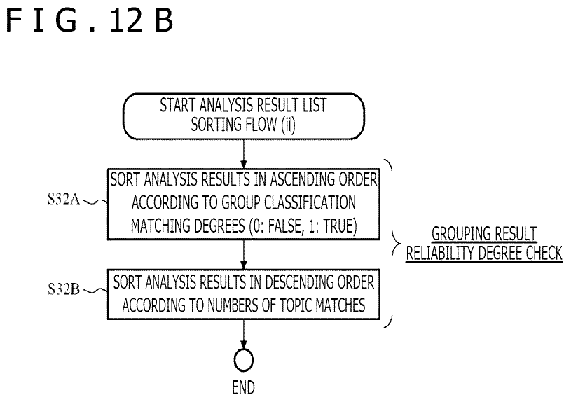

With reference to flowcharts of FIGS. 11 to 12B, description will be made of an example of a procedure of display control processing for analysis results in the user terminal 100. First, performed are steps S31 and S32 which are a procedure of sorting an analysis result list as the result of comparison and analysis of the new requirement document and a plurality of past requirement documents. Step S31, as an example, compares vector similarity degree scores between the plurality of past requirement documents, and sorts the analysis results in descending order of the vector similarity degree scores. In addition, step S32, as an example, compares group classification matching degrees between the plurality of past requirement document, and sorts the analysis results in descending order of the matching degrees (see FIG. 12B). Incidentally, in step S31, as illustrated in FIG. 12A, it is also possible to sort the analysis results in ascending order of the vector similarity degree scores (step S31A), and sort the analysis results in descending order according to the scores of differences between topic matching rates and vector similarity degrees (step S31B). Further, it is also possible to sort the analysis results in ascending order of the topic matching rates (step S31C), and sort the analysis results in descending order according to the scores of the differences between the vector similarity degrees and the topic matching rates (step S31D). Step S33 determines whether or not an analysis result display ending instruction is issued. When the analysis result display ending instruction is issued (Y), the procedure of FIG. 11 is ended. When the analysis result display ending instruction is not issued (N), the processing proceeds to step S34.

Step S34 performs data selection and filtering on the basis of the information regarding the new requirement document as a specified analysis target. The analysis target can be specified by specifying, for example, a document name, a group name, and a topic name. Next step S35 performs data selection and filtering on the basis of the information regarding the past requirement document as a specified comparison target. Specification of the analysis target can be performed by specifying, for example, a document name, a group name, and a topic name of the past requirement document.

Step S36 determines whether or not there is a group specification in the specification of the analysis target. When there is a group specification (N), the processing proceeds to step S37. When there is no group specification (Y), the processing proceeds to step S38.

According to the specified group, step S37 displays the result of grouping for the group related to the specification, the text of the group in question, the result of extraction of topics in the group in question, a difference between the extracted topics and topics in a corresponding group of the past requirement document as a comparison target, and the like.

Meanwhile, according to the specified new requirement document, step S38 displays the result of grouping for each of a plurality of groups included in the new requirement document related to the specification, the text of the plurality of groups in question, the result of extraction of topics in each of the plurality of groups in question, a difference between the extracted topics and topics in a corresponding group of the past requirement document as a comparison target, and the like. The display control procedure as described above is continued until an analysis result display ending instruction is issued (step S33).

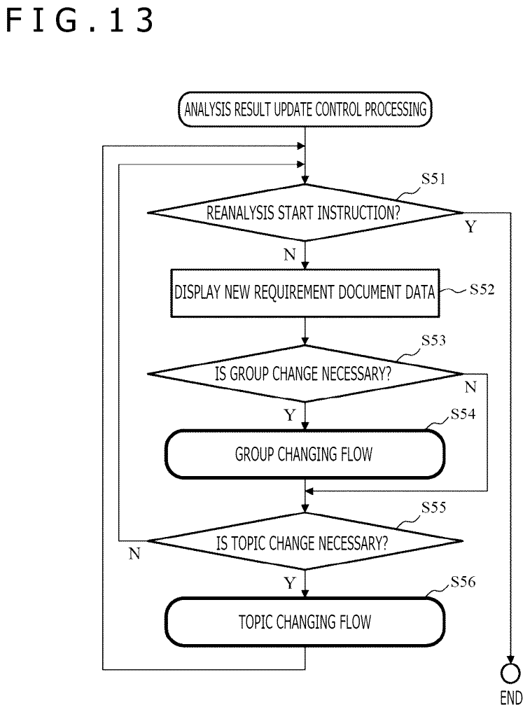

Next, with reference to FIG. 13, description will be made of an example of a procedure for update control of display of analysis results. First, when a reanalysis start instruction is given by the reanalysis start instruction button 15A or the like (Y in step S51), the procedure of FIG. 4A and FIG. 4B is performed for the new requirement document and the past requirement document being displayed on the screen, and the procedure of FIG. 13 is ended. When an instruction for the updating of the display of the analysis results is given (N in step S51), on the other hand, the data of a new requirement document as a new analysis target is displayed on the new requirement document display and editing screen 12, for example, (step S52).

Then, whether or not the changing of a group as an analysis target is necessary is determined (step S53). When the changing of the group as an analysis target is necessary (Y), a group changing flow for changing the group is performed (step S54). In addition, whether or not the changing of a topic as an analysis target is necessary is determined (step S55). When the changing of the topic as an analysis target is necessary, a topic changing flow for changing the topic as an analysis target is performed (step S56). The update control of the analysis targets is thus completed, and when the reanalysis start instruction button 15A is pressed, analysis processing is similarly performed.

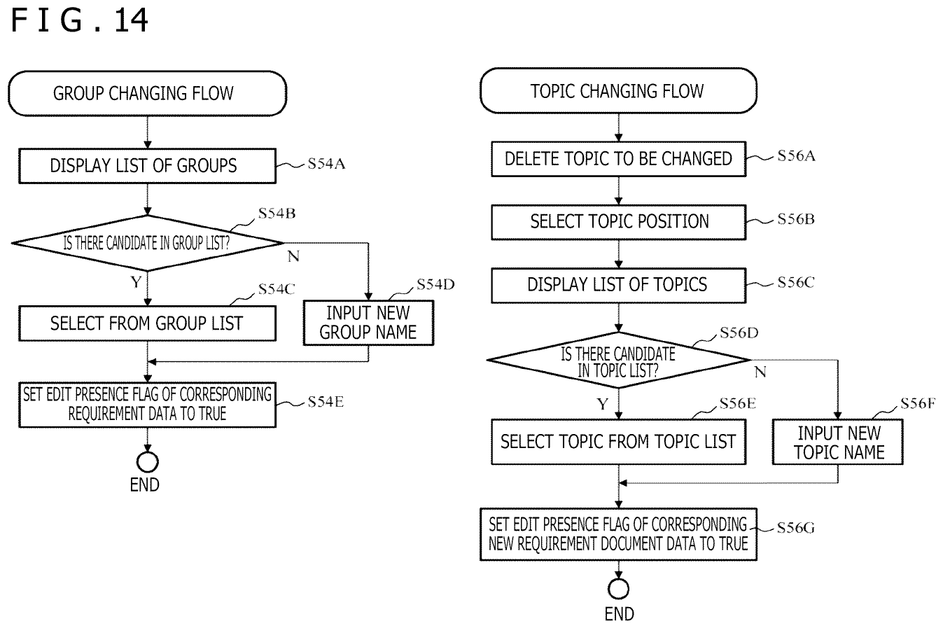

A flowchart on the left side of FIG. 14 illustrates an example of a detailed procedure of the group changing flow (step S54). When an instruction for a group change is given, a list of groups included in the new requirement document as an analysis target is displayed on the analysis and comparison target specifying display screen 2 (step S54A). The user of the user terminal 100 views the group list, and determines whether or not there is a group desired to be set as a candidate for the next analysis in the list (step S54B). When there is a group to be set as a candidate for the next analysis in the list (Y), the group is selected from the group list (step S54C). When no group to be set as a candidate is found (N), a search is made by inputting a new group name from a search box not illustrated, and a corresponding group is identified (step S54D). When a group to be set as a target for the next analysis is identified, an edit presence or absence flag indicating the presence or absence of an edit to the corresponding new requirement document is set to “TRUE.” (step S54E)

In addition, a flowchart on the right side of FIG. 14 illustrates an example of a detailed procedure of the topic changing flow (step S56). When an instruction for a topic change is given, the topic to be changed is deleted on the analysis and comparison target specifying display screen 2 from among the topics included in the new requirement document as an analysis target (step S56A). In addition, the position of a topic in the new requirement document is selected (step S56B), and a list of topics corresponding to the position is displayed (step S56C). The user of the user terminal 100 views the list, and determines whether or not there is a topic as a candidate for determination in the list (step S56D). When there is a topic as a candidate (Y), the candidate is selected from the topic list (step S56E). When there is no topic as a candidate (N), a search is made by inputting a new topic name from a search box not illustrated, and a corresponding topic is identified (step S56F). When the topic as a target for the next analysis is identified, an edit presence flag indicating an edit to the corresponding new requirement document is set to “TRUE.”

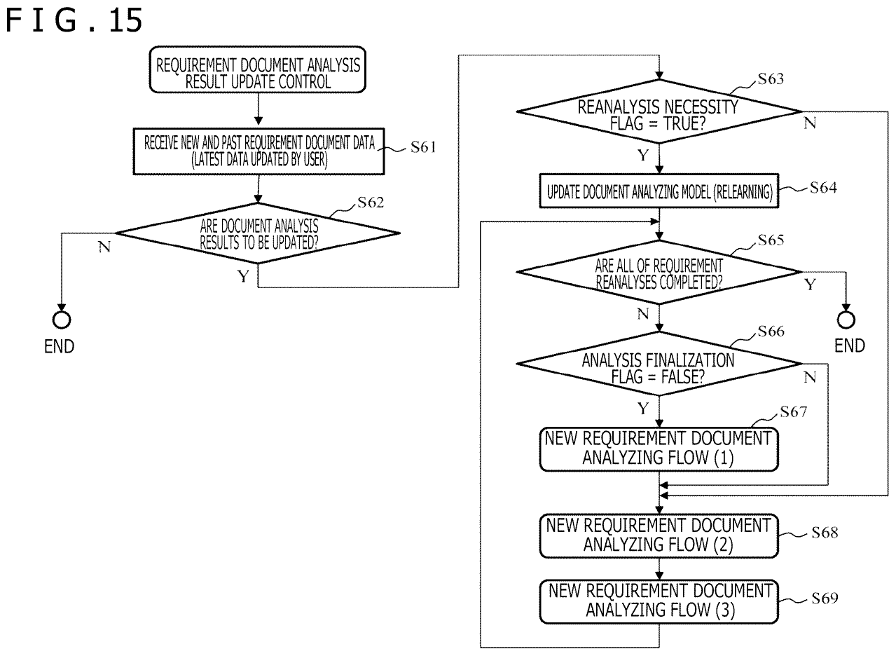

Next, with reference to a flowchart of FIG. 15, description will be made of a procedure of update control for updating the analysis results of the new requirement document. First, when latest new and past requirement documents updated by the user are received and obtained in the new requirement document managing section 2131 and the past requirement document managing section 2132 (step S61), whether or not there is a request for updating the document analysis results of the new requirement document is determined (step S62). When there is no update request, the operation is ended (N). When there is an update request (Y), whether a reanalysis necessity flag is set to “TRUE” is determined (step S63). When the reanalysis necessity flag is set to TRUE, the document analyzing model is updated (relearned) in the document analysis model generating section 212 (step S64), and a reanalysis of the new requirement document by the document analyzing model is performed (steps S65 to S69). Specifically, when a flag indicating whether or not the analysis of the new requirement document is finalized is “FALSE” (analysis is not yet finalized) in step S66, the procedure of FIG. 4A (steps S11 to S18: a new requirement document analyzing flow (1)) is performed. When the analysis of the new requirement document is finalized and a document analysis finalization flag is set to “TRUE” (N), steps S11 to S18 are omitted, and the procedure of FIG. 4B (steps S21 to S26: new requirement document analyzing flows (2) and (3)) is performed.

Embodiments have been described above. However, the following document analyzing methods can also be adopted.
(1) A reliability degree score can be recalculated by multiplying a numerical value indicating the inter-document similarity degree, the topic matching rate, or the like by a reliability degree coefficient R_{NCU} set according to the number of customer (=document issuer) matches between the new requirement document and the past requirement document. This is based on a fact that the degree of reliability of the analysis results is improved as the number of document issuer matches between the new requirement document and the past requirement document increases.
(2) The reliability degree score is recalculated by multiplying the numerical value indicating the inter-document similarity degree or the topic matching rate by a reliability degree coefficient R_{NRG} set according to the number of matches between requirement groups of the new requirement document and the past requirement document. This is based on a fact that the degree of reliability of the analysis results is improved as the number of times of appearance of the same group increases.
(3) The reliability degree score is recalculated by multiplying the numerical value indicating the inter-document similarity degree or the topic matching rate by a reliability degree coefficient R_{RNR} corresponding to a ratio between a total number (M) of requirements of the new requirement document and a total number (N) of requirements of the past requirement document. This is based on a fact that the degree of reliability of the analysis results is improved as the ratio between the total number (M) of requirements of the new requirement document and the total number (N) of requirements of the past requirement document becomes closer to 1.

It is to be noted that the present invention is not limited to the foregoing embodiments and includes various modifications. The foregoing embodiments are described in detail to describe the present invention in an easily understandable manner, and are not necessarily limited to embodiments including all of the described configurations. Further, a part of a configuration of a certain embodiment can be replaced with a configuration of another embodiment, and a configuration of another embodiment can be added to a configuration of a certain embodiment. Further, for a part of a configuration of each embodiment, another configuration can be added, deleted, or substituted.

Further, a part or the whole of configurations, functions, processing units, and processing means described above may be implemented by hardware by making design thereof by an integrated circuit. Further, configurations and functions described above may be implemented by software by interpreting and executing a program implementing each function by a processor. Such information as a program, a table, and a file for implementing the functions can be stored in a recording device such as a memory, a hard disk, or an SSD or a recording medium such as an IC card, an SD card, or a DVD.

### DESCRIPTION OF REFERENCE SYMBOLS

2: Analysis and comparison target specifying display screen
3: Analysis result list display and analysis result detail selecting screen
4: Analysis result detail display and editing screen
10: Classification reliability degree score table
11: Topic extraction reliability degree score table
12: New requirement document display and editing screen
13: Past requirement document display and editing screen
14: Topic difference display screen
15A: Reanalysis start instruction button
15B: Prev button
15C: Next button
100: User terminal
104: Hard disk drive
105: Input-output control unit
106: Communication control unit
107: Display control unit
108: Input device
109: Display
200: Document analyzing device
204: Hard disk drive
205: Input-output control unit
206: Communication control unit
207: Display control unit
211: Document analysis processing section
212: Document analysis model generating section
213: Document analysis result managing section
214: Document analysis result input-output section
215: Document analysis reliability degree calculating section
2111: Group classifying section
2112: Topic extracting section
2113: Topic difference extracting section
2114: New requirement document preparing section
2123: Vector similarity degree calculating model generating section
2131: New requirement document managing section
2132: Past requirement document managing section
2133: Topic data managing section
2134: Group data managing section
2135: Document analysis result data managing section
2136: Document analysis result update control section
2151: Topic matching rate calculating section
2152: Vector similarity degree calculating section
2153: Topic matching rate and vector similarity degree difference calculating section

1. A document analyzing device comprising:
a group classifying section configured to determine requirement items included in a first document as a target of analysis, and classify the requirement items into a plurality of groups;
a topic extracting section configured to extract, as topics, terms related to the requirement items classified into the plurality of groups;
a topic difference extracting section configured to compare topics included in groups of an already analyzed second document different from the first document with the topics included in the groups of the first document, and extract differences between the topics included in the groups of the second document and the topics included in the groups of the first document; and
an analysis result output section configured to output an analysis result indicating a result of the analysis including the differences to an outside.

2. The document analyzing device according to claim 1, further comprising:
an analysis reliability degree calculating section configured to calculate a degree of reliability of the analysis of the first document,
wherein the analysis reliability degree calculating section further includes
a topic matching rate calculating section configured to calculate a topic matching rate by comparing the topics included in the requirement items of the first document with the topics included in requirement items in the second document,
a vector similarity degree calculating section configured to calculate a vector similarity degree of the terms included in the first document, and
a topic matching rate and vector similarity degree difference calculating section configured to calculate the degree of reliability of the analysis of the first document by calculating a difference between the topic matching rate and the vector similarity degree.

3. The document analyzing device according to claim 1, wherein,
according to the differences between the topics of the first document and the topics of the second document, the topic difference extracting section identifies a common topic included in common in the first document and the second document, a lacking topic lacking in the first document, and a new topic existing only in the first document.

4. The document analyzing device according to claim 1, wherein
the topic extracting section is configured to convert the terms extracted as topics into other terms according to a database.

5. The document analyzing device according to claim 1, wherein
the analysis result output section includes a result of classification by the group classifying section and the topics extracted by the topic extracting section in the analysis result and outputs the analysis result, and allows the topics to be edited in an external device.

6. A document analyzing program configured to make a computer perform:
a step of determining requirement items included in a first document as a target of analysis, and classifying the requirement items into a plurality of groups;
a step of extracting, as topics, terms related to the requirement items classified into the plurality of groups;
a step of comparing topics included in groups of an already analyzed second document different from the first document with the topics included in the groups of the first document, and extracting differences between the topics included in the groups of the second document and the topics included in the groups of the first document; and
a step of outputting an analysis result indicating a result of the analysis including the differences to an outside.

7. The document analyzing program according to claim 6, further comprising:
a step of calculating a degree of reliability of the analysis of the first document,
wherein the step of calculating the degree of reliability further includes
a step of calculating a topic matching rate by comparing the topics included in the requirement items of the first document with the topics included in requirement items in the second document,
a step of calculating a vector similarity degree of the terms included in the first document, and
a step of calculating the degree of reliability of the analysis of the first document by calculating a difference between the topic matching rate and the vector similarity degree.
